(19) United States
(12) Patent Application Publication
(10) Pub. No.: US 2018/0243783 A1
(43) Pub. Date: Aug. 30, 2018

(54) APPARATUS AND METHOD FOR ROLL-TO-ROLL MEMBRANE MANUFACTURE

(71) Applicant: GENERAL ELECTRIC COMPANY, Schenectady, NY (US)

(72) Inventors: Dean David MARSCHKE, Eden Prairie, MN (US); Brian J. RUDIE, Rockford, MN (US)

(21) Appl. No.: 15/553,304

(22) PCT Filed: Feb. 26, 2015
(86) PCT No.: PCT/US15/17711

§ 371 Date: Aug. 24, 2017

(51) Int. Cl. B05C 3/152; B01D 71/42; B01D 69/02; B01D 67/00; B05D 1/18; B05D 1/36; D06B 3/32

(52) U.S. Cl. CPC B05C 3/152; B01D 71/42; B01D 69/02; B01D 67/0095; B01D 67/0093; B01D 2323/42; B05D 1/36; D06B 3/32; B01D 2325/36; B01D 2325/34; B05D 1/18

(57) ABSTRACT

A roll-to-roll process and apparatus is disclosed for treatment of a membrane substrate. The apparatus and process processes the membrane substrate in a forward direction using one or more treatment solutions, and then processes the membrane substrate in a reverse direction using other treatment solutions. The treatment solutions used in the forward and reverse directions are preferably chosen so that the treatment sequence is the same in both directions. In this manner, the membrane substrate can accumulate reaction time by repeated processing in forward and reverse directions. t,?

### FIELD OF INVENTION

The present disclosure relates to continuous roll-to-roll processes and systems.

### BACKGROUND OF THE INVENTION

The following paragraphs are not an admission that anything discussed in them is prior art or part of the knowledge of persons skilled in the art.

Production of membranes, such as ion exchange membranes or hydrophilic membranes, may result in variations in performance when using batch processes. For example, polyacrylonitrile polymer membranes are functionalized to be hydrophilic through a batch acid dip process. The resulting hydrophilic membranes may be used to separate oil from water. However, using a batch soaking process to treat the polyacrylamide polymer membrane with acid results in undesirable performance variations between batches.

It is desirable to produce membranes with fewer performance variations than membranes produced using batch processes.

### BRIEF DESCRIPTION OF THE INVENTION

The following introduction is intended to introduce the reader to this specification but not to limit or define any claimed invention. One or more inventions may reside in a combination or sub-combination of the apparatus elements or method steps described below or in other parts of this document. The inventors do not waive or disclaim their rights to any invention or inventions disclosed in this specification merely by not describing such other invention or inventions in the claims.

Since using a batch process may result in undesirable performance variations between batches, it is desirable to replace such batch processes with continuous roll-to-roll processes. Continuous roll-to-roll processes that require extended reaction times in a given reaction solution may use, in order to provide the desired reaction time, slower rates of linear travel (feet-per-minute) in a smaller reaction zone, or faster rates of linear travel in a larger reaction zone. Reduced rates of linear travel, however, may also affect the reaction times of other steps in the roll-to-roll process. Larger reaction zones may require larger physical footprints.

Generally, the present disclosure provides a method and system for continuous roll-to-roll processing of a membrane substrate in a plurality of treating solutions where the total reaction time in at least one treating solution is accumulated by rolling the membrane substrate multiple times between the two rolls. Rolling the membrane substrate between the two rolls multiple times allows the membrane substrate to be treated with a treating solution multiple times. For example, processing the membrane substrate in a forward direction and then a reverse direction results in a total reaction time that is twice as long as the reaction time for a single pass. In another example, processing the membrane substrate in a forward direction, rolling the membrane back to the first roll, and again processing the membrane substrate in a forward direction results in a total reaction time that is twice as long as the reaction time for a single pass. The membrane substrate may accumulate reaction time without traveling at a linear velocity that affects other steps in the process, and without requiring an increase in reaction zone size. The method and system in an embodiment be used to treat a porous membrane or porous membrane laminate, such as an ion exchange membrane.

An apparatus according to the present disclosure has a first roll and a second roll. Both the first roll and the second roll are each windable and unwindable. In this manner, the membrane substrate may be unrolled from the first roll onto the second roll, or unrolled from the second roll onto the first roll. For convenience, in the present disclosure, unrolling the membrane substrate from the first roll onto the second roll and treating it with at least one treating solution is referred to a “forward processing” or “processing in the forward direction”, and unrolling the membrane substrate from the second roll onto the first roll and treating it with at least one treating solution is referred to a “reverse processing” or “processing in the reverse direction”.

In a particular example, the membrane substrate is treated with at least one of the plurality of treating solutions as it is transferred between the two rolls. Once the membrane substrate has been rolled from one roll onto the other roll, the processing direction of the membrane substrate may be reversed and the membrane substrate is then re-rolled onto the original roll while being treated with at least one of the plurality of treating solutions. Alternatively, once the membrane substrate has been rolled from one roll onto the other roll, the treated membrane substrate may be re-rolled onto the original roll without treatment.

The membrane substrate is able to processed in the forward direction only being treated with a subset of the plurality of the treating solutions. The membrane substrate is also able to be processed in the reverse direction only being treated with a different subset of the plurality of the treating solutions. The membrane substrate is also able to be processed in both directions with yet another different subset of the plurality of the treating solutions. In this manner, the membrane substrate may be treated with different treating solutions, or a different order of treating solutions, when it is processed in the forward direction than when it is processed in the reverse direction.

It should be understood that a subset of the treating solutions may include treating solutions from other subsets. For example, one subset may be made up of treating solutions A, B, C, and D, while a different subset may be made up of treating solutions C, D, E and F, and yet another different subset may be made up of treating solution B. In such an example, these are all different subsets of the plurality of treating solutions A, B, C, D, E and F.

In an exemplary method according to the present disclosure, when forward processing the membrane substrate, the method includes treating the membrane substrate with a first subset of the treating solutions, and not treating the membrane substrate with a second subset of the treating solutions. When reverse processing the membrane substrate, the method includes treating the membrane substrate with the second subset of the treating solutions, and not treating the membrane substrate with the first subset of the treating solutions. The exemplary method also includes treating the membrane substrate with a third subset of the treating solutions when forward processing and reverse processing. The sequence of treating solutions in the embodiment is the same when considered in the forward direction as when considered in the reverse direction so as to allow the membrane substrate to accumulate reaction time in at least one treating solution each time the membrane substrate is processed.

In another exemplary method according to the present disclosure, the membrane substrate is first treated by forward processing with a first subset of the treating solutions and a second subset of the treating solutions. The membrane substrate is the treated by repeated reverse processing and/or forward processing with the second subset of the treating solutions enough times to result in a desired total reaction time for the second subset of treating solutions. The membrane substrate may then be treated, by forward or reverse processing, with at least a third subset of the treating solutions.

In a further example of an apparatus according to the present disclosure, the apparatus includes a first roll and a second roll where the membrane substrate is windable and unwindable on both the first and second rolls. The membrane substrate is treatable with at least one treating solution as the membrane substrate is processed in a forward direction, in a reverse direction, or in both the forward and the reverse direction.

In a further example of a method according to the present disclosure, the method includes: processing the membrane substrate in a forward direction by treating the membrane substrate with the treating solution while unwinding the membrane substrate from a first roll to a second roll; rewinding the treated membrane substrate from the second roll back to the first roll; and processing the treated membrane substrate in a forward direction by treating the treated membrane substrate with the treating solution while unwinding the treated membrane substrate from the first roll to the second roll.

### BRIEF DESCRIPTION OF THE DRAWINGS

Embodiments of the present disclosure will now be described, by way of example only, with reference to the attached Figures.

FIG. 1 illustrates one configuration of an example of an apparatus according to the present disclosure.

FIG. 2 illustrates another configuration of the apparatus illustrated in FIG. 1.

FIG. 3 illustrates one configuration of another example of an apparatus according to the present disclosure.

FIG. 4 illustrates another configuration of the apparatus illustrated in FIG. 3.

### DETAILED DESCRIPTION OF THE INVENTION

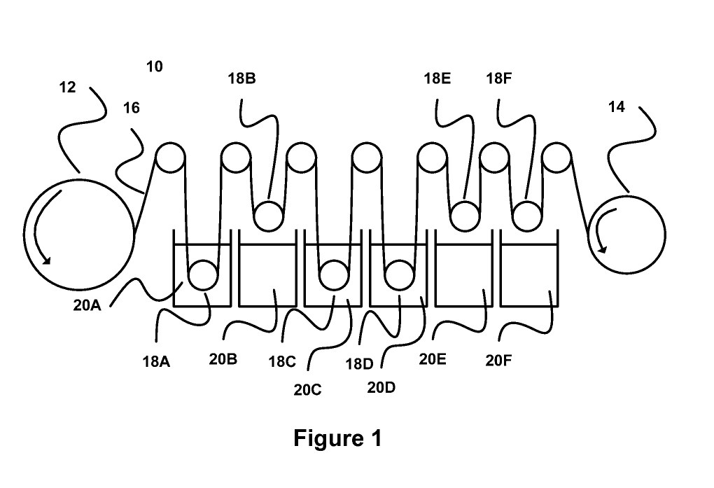

FIG. 1 illustrates roll-to-roll processing apparatus 10. The apparatus 10 is an example of an immersion dip treatment apparatus. The apparatus 10 includes a first roll 12, and a second roll 14. A membrane substrate 16 is wound from the first roll to the second roll, passing around rollers 18A-F that are immersable in treating solutions 20A-F.

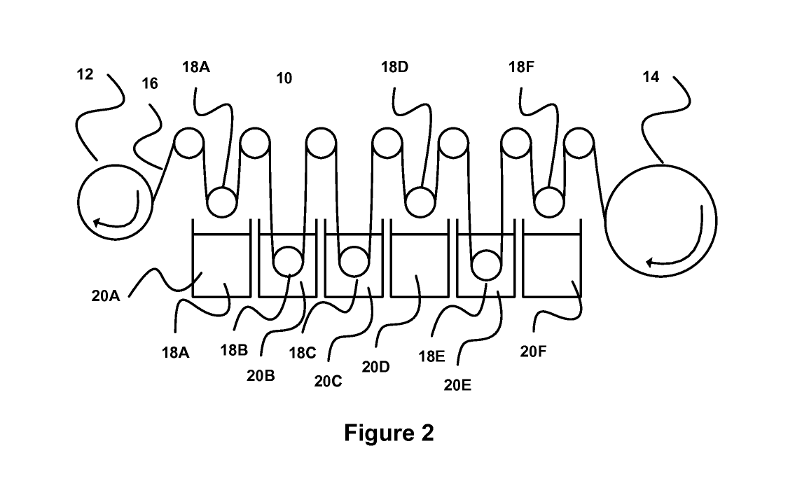

Rollers 18A-F are moveable between treating arrangements and non-treating arrangements, though it would be understood that each roller is independently movable and the configurations illustrated in FIGS. 1 and 2 are not the only possible configurations of the apparatus 10.

In one example, as illustrated in FIG. 1, rollers 18A, 18C, and 18D are positioned in treating arrangements to expose the membrane substrate 16 to the treating solutions 20A, 20C and 20D. The rollers 18B, 18E and 18F are positioned in non-treating arrangements, which allow the membrane substrate to be processed without being treated by the treating solutions 20B, 20E and 20F.

Once the membrane substrate has been treated in the forward direct using the configuration illustrated in FIG. 1, thereby exposing the membrane substrate to the treating solutions 20A, 20C and 20D, the membrane substrate is treated in the reverse direction by unwinding the membrane substrate from the second roller 14 onto the first roller 12, as illustrated in FIG. 2. In this manner, the membrane substrate is exposed to the treating solutions 20E, 20C and 20B, in that order. In the configuration illustrated in FIG. 2, roller 18F remains in the non-treating arrangement.

In some examples, the treating solutions 20A and 20E have the same chemical compositions, and the treating solutions 20B and 20D have the same chemical compositions. In such situations, the membrane substrate 16 is treated with the same sequence of treating solutions in both FIGS. 1 and 2. For example, when treating solutions 20A and 20E are ethanol solutions, when treating solutions 20B and 20D are basic solutions, and when treating solution 20C is an acidic solution, the membrane substrate is treated with, in order: ethanol, acid, then base, in both the forward processing direction of FIG. 1 and the reverse processing direction of FIG. 2.

The membrane substrate 16 is treated with treating solution 20C for a total time calculated on the distance the membrane substrate is contacting the treating solution 20C, divided by the linear velocity of the membrane substrate (feet per minute), multiplied by the number of times the membrane substrate is processed in either the forward or reverse directions.

In one specific example, the membrane substrate 16 is treated using the protocol shown in Table 1, where solutions 20A and 20E have the same chemical composition, and where solutions 20B and 20D have the same chemical compositions:

TABLE 1

| Processing | 18A | 18B | 18C | 18D | 18E | 18F |
|---|---|---|---|---|---|---|
| direction | position | position | position | position | position | position |
| Forward | Treating | Not | Treating | Treating | Not | Not |
| | | treating | | | treating | treating |
| Reverse | Not | Treating | Treating | Not | Treating | Not |
| | treating | | | Treating | | treating |
| Forward | Treating | Not | Treating | Treating | Not | Not |
| | | treating | | | treating | treating |
| Reverse | Not | Treating | Treating | Not | Treating | Not |
| | treating | | | treating | | treating |
| Forward | Treating | Not | Treating | Treating | Not | Treating |
| | | treating | | | treating | |

Using the protocol in Table 1, the membrane substrate 16 is treated with treating solution 20C five times. At a linear rate of 2 feet per minute, and a reaction distance of 120 feet, the membrane substrate 16 is treated for a total of 120/2*5=300 minutes, or 5 hours. In order to achieve the same 300 minute reaction time using only a single-pass roll-to-roll process, it would be necessary to treat the membrane substrate at a linear velocity of 0.4 feet per minute if the distance was kept at 120 feet, or it would be necessary to increase the distance to 600 feet if the linear velocity was kept at 2 feet per minute.

The apparatus 10 may have additional rollers and treating solutions. For example, the apparatus may include a roller and treating solution between roller/treating solution 18E/20E and roller/treating solution 18F/20F. This additional treating solution may be a buffer solution to bring the porous membrane to a desired pH.

In an exemplary process, a polyacrylonitrile membrane, which has pores of 0.01 microns and a molecular weight cut off about 20,000 to 50,000 Daltons, is treated with acid to generate a hydrophilic membrane. The polyacrylonitrile membrane is treated using the protocol shown in Table 1, where: treating solution 20A is a solvent-exchange solution, treating solution 20B is a basic solution, treating solution 20C is an acidic solution, treating solution 20D is a basic solution, treating solution 20E is a solvent-exchange solution, and treating solution 20F is a humectant solution.

A solvent-exchange solution, such as ethanol solution, removes water from the membrane by exchanging the water for ethanol. A humectant solution, for example a solution of about 20% glycerol in water, enables a porous membrane to be dried while maintaining stability of the membrane morphology.

At a linear rate of 2 feet per minute, in a reaction tank that provides for 120 feet of reaction distance, and five processing directions, the polyacrylonitrile membrane is treated with acid for a total of 5 hours, is rinsed with a basic solution after every acid treatment, and is rinsed in a humectant solution after the final acid treatment.

The acid bath may be heated, for example to a temperature of up to 41° C. Heating the acid bath increases the reaction rate and allows the total reaction time to be decreased, for example by increasing the linear velocity of the membrane, decreasing the reaction distance, or reducing the number of times the membrane is processed. Raising the temperature from 21° C. to 31° C. doubles the reaction rate, and allows the linear velocity to be increased from 2 feet per minute to 4 feet per minute, thereby doubling the amount of hydrophilic membrane produced per unit time. Raising the temperature from 31° C. to 41° C. double the reaction rate again, and allows the linear velocity to be increased to 8 feet per minute, again doubling the amount of hydrophilic membrane produced per unit time.

The linear velocity of any processing step may independently differ from the linear velocity of other processing steps. Changing the linear velocity of a processing step changes the reaction time of the treating solutions used in that processing step. For example, a method may include a first processing step at a first linear velocity for treating the membrane substrate with a first subset of the treating solutions. The membrane substrate may then be treated in a second processing step at a second linear velocity for treating the membrane substrate with a second subset of the treating solutions. The second linear velocity may be reduced in comparison to the first linear velocity if it is desirable to increase the reaction time of the membrane substrate in the second subset of treating solutions.

The apparatus 10 may be used in alternate configurations than those illustrated in FIGS. 1 and 2. For example, in an exemplary method the rollers 18A and 18C, are first positioned in treating arrangements to expose the membrane substrate 16 to the treating solutions 20A and 20C. Once the membrane 16 has been treated in a forward direction, the roller configuration is changed to expose the membrane substrate 16 to the treating solution 20C. After processing in one or more forward and/or reverse directions in order to expose the membrane 16 to the desired total reaction time for treating solution 20C, the roller configuration is changed to expose the membrane substrate 16 to one or more other treating solutions.

An exemplary protocol for such a method is illustrated in Table 2. In this protocol, membrane 16 is exposed to treating solution 20C five times and is exposed to treating solutions 20D and 20F after the final exposure to treating solution 20C. In such an exemplary protocol, treating solutions 20B and 20E may be omitted.

Using such a protocol, and if treating solution 20A is an ethanol solution, treating solution 20C is an acidic solution, treating solution 20D is a basic solution, and treating solution 20F is a glycol solution, the membrane is treated first with ethanol to remove water from the membrane, then treated five times with acid. The acidic membrane is then neutralized by treating it with the basic solution, and then treated with the glycol solution. The protocol may include treating the membrane with a buffer solution between the basic solution and the glycol solution.

TABLE 2

| Processing | 18A | 18C | 18D | 18F |
|---|---|---|---|---|
| direction | position | position | position | position |
| Forward | Treating | Treating | Not | Not |
| | | | treating | treating |
| Reverse | Not | Treating | Not | Not |
| | treating | | treating | treating |
| Forward | Not | Treating | Not | Not |
| | treating | | treating | treating |
| Reverse | Not | Treating | Not | Not |
| | treating | | treating | treating |
| Forward | Not | Treating | Treating | Treating |
| | treating | | | |

If a protocol resulted in the method finishing with the membrane travelling in a reverse processing direction, the apparatus may include roller 18B instead of roller 18D, and roller 18F may be positioned after roller 18B. In such a manner, the membrane 16 could be exposed to treating solutions 20C, 20B and 20F, in that order, in the final reverse processing step.

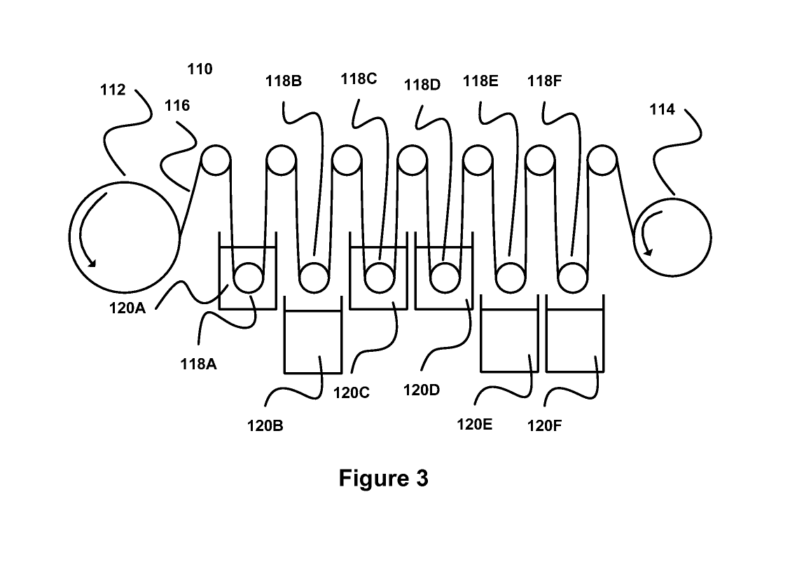

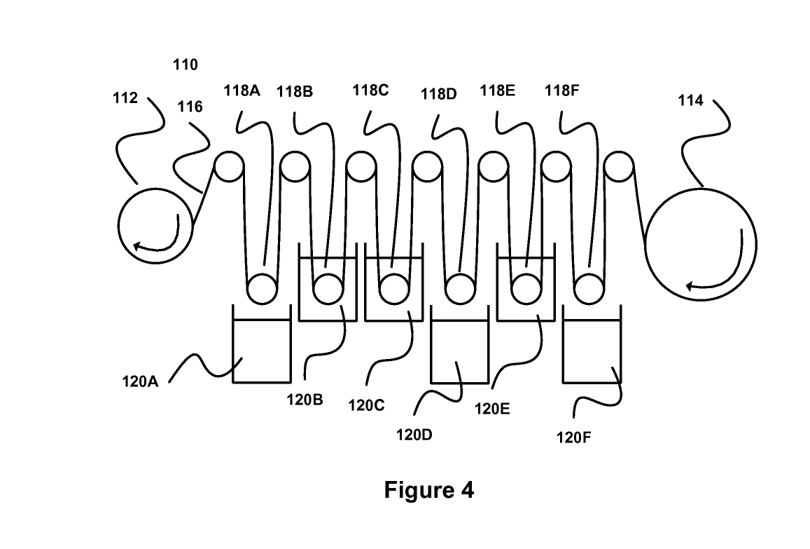

FIGS. 3 and 4 illustrate two configurations of an alternative apparatus 110 for a treating a membrane substrate. The components of apparatus 110 are the same as those discussed above with respect to apparatus 10 and, accordingly, have parallel reference numbers and are not discussed in detail. In contrast to apparatus 10, apparatus 110 includes movable treatment baths 120A-F, but stationary rollers 118A-F. FIG. 3 illustrates treatment baths 120A, 120C and 120D in treating arrangements, and treatment baths 120B, 120E and 120F in non-treating arrangements. FIG. 4 illustrates treatment baths 120B, 120C and 120E in treating arrangements, and treatment baths 120A, 120D and 120F in non-treating arrangements. Apparatus 110 is capable of treating the membrane substrate according to the protocols shown in Tables 1 and 2.

As illustrated above, the sequence of treatments may be the same when considered in the forward direction as when considered in the reverse direction. For example, the membrane substrate may be treated in a forward processing direction with solutions in the order A, B, C then D, and treated in the reverse processing direction with solutions in the same order A, B, C then D. Since the membrane substrate is being transferred between the first roll and the second roll, the solutions may be physically set up in the order: [first roll]-A′, B′, C′, D′, D″, C″, B″, A″-[second roll], where a “prime” indicates the subset of the treating solutions used in the forward processing direction, and “double prime” indicates the subset of the treating solutions used in the reverse processing direction. Treating solutions without a prime or double prime are shared in both the forward and reverse processing directions. It is beneficial to share a treating solution in both the forward and reverse processing so as to avoid duplication of the treating solution.

In view of the above, it should be understood that the chemical compositions of the treating solutions used to treat the membrane substrate may be the same regardless of the processing direction. That is, processing in the forward direction may include treating the membrane with the same solution, or with a separate solution of the same chemical composition that is used when processing in the reverse direction. For example, treating solutions A′ and A″ have the same chemical composition.

Other orders may be used to treat the membrane substrate with treating solutions A, B, C then D in both the forward and reverse processing directions. For example: [first roll]-A′, D″, B′, C, B″, D′, A″-[second roll]; [first roll]-A′, D″, C″, B, C′, D′, A″-[second roll]; [first roll]-D″, C″, B″, A, B′, C′, D′-[second roll]; or [first roll]-D″, C″, A′, B, C′, D′, A″-[second roll] all result in the membrane substrate being treated with treating solutions in the order A, B, C then D in both the forward and reverse directions.

Apparatuses according to the present disclosure may use any methods, techniques, or components known in the art for treating the membrane substrate with a treating solution. Various method, techniques, or components may be used to process the membrane substrate without treatment by one or more of the treating solutions.

Depending on the roll-to-roll process being used to treat the membrane substrate, processing the membrane substrate without being treated by one or more of the treating solutions may be achieved by separating the membrane substrate from one or more of the treating solutions, or by not applying one or more of the treating solutions to the membrane substrate. The membrane substrate may be separated from a treating solution, or may not have a treating solution applied, by changing the membrane substrate from a treating arrangement to a non-treating arrangement.

For example, the apparatus may include one or more immersion dip treatment baths containing the treating solutions. In such an apparatus, a roller may be at least partially immersed in the treating solution so that the membrane substrate contacting the roller is exposed to the treating solution. Non-treating arrangements may include a roller that is completely removed from the treating solution so that the membrane substrate contacting the roller is not exposed to the treating solution. The membrane substrate may be separated from the treating solutions using rollers that are independently moveable between treating arrangements and non-treating arrangements, such as illustrated in FIGS. 1 and 2. Alternatively, the membrane substrate may be separated from the treating solutions using treatment baths that are independently moveable between treating arrangements and non-treating arrangements, such as illustrated in FIGS. 3 and 4.

In another alternative, the membrane substrate may be separated from the treating solutions using treating solutions that are drainable into corresponding holding tanks. In such an alternative, when a treatment solution is contained in a treating bath, the membrane substrate is in a treating arrangement. When a treatment solution is drained in a holding tank, the membrane substrate is in a non-treating arrangement.

In yet another alternative, the apparatus may include one or more coating rollers to apply the treating solution to the membrane substrate. In such an apparatus, a non-treating arrangement may include a coating roller that is separated from the membrane substrate, a coating roller that is separated from the treating solution, a pickup roller that is separated from the coating roller or from the treating solution, a metering blade that removes substantially all of the treating solution from the coating roller or from the pickup roller, or any combination thereof.

In still another alternative, the apparatus may include a spray treatment to apply the treating solution to the membrane substrate. In such an apparatus, a non-treating arrangement may include a sprayer that is turned off

An apparatus according to the present disclosure may additionally include one or more dryers for drying the membrane after the membrane has been treated with one of the treating solutions. For example, the apparatus may include a dryer for drying the membrane after the membrane has been treated with ethanol. Such a dryer may remove substantially all of the ethanol before the membrane is treated with, for example, an acidic solution. Removing a treating solution before the membrane is treated with a subsequent treating solution may enhance the effects of the subsequent treating solution, or may reduce the amount of chemicals used in the subsequent treating solution.

Alternatively, or additionally, the apparatus may include a dryer for drying the membrane after the membrane has been treated with the humectant solution. Such a dryer may remove substantially all of the humectant before the membrane is wound up, for example for storage or filter assembly. A dried porous membrane may be stored without degradation for longer periods of time than wet porous membrane.

A dryer which may be used in the apparatus is sized and shaped to accommodate entry of the membrane along its width, and includes an under-skirt movable between an open and a closed position, and rollers that are moveable between a drying position and a non-drying position. In the drying position, the rollers position the membrane within the length of the dryer and the under-skirt is in the closed position, creating a tunnel through with the membrane passes as it is dried by the dryer. In the non-drying position, the membrane is outside the dryer.

An alternative dryer which may be used in the apparatus is sized and shaped to accommodate entry of the membrane along its width. The membrane travels through the dryer, and the dryer is turned on if the membrane is to be dried and it turned off if it is not necessary for the membrane to be dried.

In the preceding description, for purposes of explanation, numerous details are set forth in order to provide a thorough understanding of the embodiments. However, it will be apparent to one skilled in the art that these specific details are not required. Accordingly, what has been described is merely illustrative of the application of the described embodiments and numerous modifications and variations are possible in light of the above teachings.

Since the above description provides example embodiments, it will be appreciated that modifications and variations can be effected to the particular embodiments by those of skill in the art. Accordingly, the scope of the claims should not be limited by the particular embodiments set forth herein, but should be construed in a manner consistent with the specification as a whole.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An apparatus for continuous roll-to-roll processing of a membrane substrate with a first treating solution, a second treating solution, and a third treating solution, the apparatus comprising:
a first roll and a second roll, the membrane substrate being windable and unwindable on both the first and second rolls to process the membrane substrate in a forward direction and a reverse direction;
the first treating solution for treating the membrane substrate as the membrane substrate is processed in the forward direction but not in the reverse direction;
the second treating solution for treating the membrane substrate as the membrane substrate is processed in the reverse direction but not in the forward direction; and
the third treating solution for treating the membrane substrate as the membrane substrate is processed in both the forward and the reverse directions.

2. The apparatus according to claim 1, further comprising rollers associated with the first treating solution and the second treating solution, each of the rollers being independently switchable between a treating arrangement and a non-treating arrangement.

3. The apparatus according to claim 1, further comprising treatment baths for holding the first and second treating solutions, each of the treatment baths being independently movable between a treating arrangement and a non-treating arrangement.

4. The apparatus according to claim 1, further comprising treatment baths for holding the first and second treating solutions, and holding tanks in fluid communication with the treatment baths, each of the treating solutions in the treatment baths being independently drainable into a holding tank.

5. The apparatus according to claim 1, further comprising a plurality of treating solutions for treating the membrane substrate as the membrane substrate is processed in the forward direction but not in the reverse direction, and a plurality of treating solution for treating the membrane substrate as the membrane substrate is processed in the reverse direction but not in the forward direction.

6. The apparatus according to claim 1, wherein the first treatment solution, the second treatment solution , and the third treating solutions are arranged in a sequence so that the membrane substrate is treatable with the same sequence of treating solutions when the membrane substrate is processed in both the forward and reverse directions.

7. An apparatus for continuous roll-to-roll processing of a membrane substrate with a plurality of treating solutions, the apparatus comprising:
a first roll and a second roll, the membrane substrate being windable and unwindable on both the first and second rolls,
the plurality of treating solutions each being changeable between a treating configuration and a non-treating configuration for independently treating the membrane substrate as the membrane substrate is processed in a forward direction or in a reverse direction,
wherein the membrane substrate is treatable with a first subset of the plurality of treating solutions and not treatable with a second subset of the plurality of treating solutions when first subset of the plurality of treating solutions is in the treating configuration and the second subset of the plurality of treating solutions is in the non-treating configuration,
wherein the membrane substrate is treatable with the second subset of the plurality of treating solutions and not treatable with the first subset of the plurality of treating solutions when the second subset of the plurality of treating solutions is in the treating configuration and the first subset of the plurality of treating solutions is in the non-treating configuration, and
wherein the membrane substrate is treatable with a third subset of the plurality of treating solutions when the third subset of the plurality of treating solutions is in the treating configuration.

8. The apparatus according to claim 7, further comprising rollers associated with the first and second subsets of the plurality of treatment baths, each of the rollers being independently switchable between a treating arrangement and a non-treating arrangement.

9. The apparatus according to claim 7, further comprising treatment baths for holding the plurality of treating solutions, each of the treatment baths being independently movable between a treating arrangement and a non-treating arrangement.

10. The apparatus according to claim 7, further comprising treatment baths for holding the plurality of treating solutions, and holding tanks in fluid communication with the treatment baths, each of the treating solutions in the treatment baths being independently drainable into a holding tank.

11. The apparatus according to claim 7, wherein the plurality of treating solutions are arranged in a sequence so that the membrane substrate is treatable with the same sequence of treating solutions when the membrane substrate is processed in both the forward and reverse directions.

12. A method of treating a membrane substrate with a plurality of treating solutions in a roll-to-roll process, the method comprising:
processing the membrane substrate in a forward direction by treating the membrane substrate with a first subset of the plurality of treating solutions and not treating the membrane substrate with a second subset of the plurality of treating solutions;
processing the membrane substrate in a reverse direction by treating the membrane substrate with the second subset of the plurality of treating solutions and not treating the membrane substrate with the first subset of the plurality of treating solutions; and
processing the membrane substrate in forward and reverse directions by treating the membrane substrate with a third subset of the plurality of treating solutions.

13. The method according to claim 12, further comprising:
switching the first subset of the plurality of treating solutions from treating arrangements to non-treating arrangements, and switching the second subset of the plurality of treating solutions from non-treating arrangements to treating arrangements.

14. The method according to claim 12, further comprising:
moving rollers associated with the first subset of the plurality of treating solutions between treating arrangements and non-treating arrangements; and
moving rollers associated with the second subset of the plurality of treating solutions between treating arrangements and non-treating arrangements.

15. The method according to claim 12, wherein:
moving treatment baths containing the first subset of the plurality of treating solutions between treating arrangements and non-treating arrangements; and
moving treatment baths containing the second subset of the plurality of treating solutions between treating arrangements and non-treating arrangements.

16. The method according to claim 12, wherein:
transferring the first subset of the plurality of treating solutions between treatment baths and corresponding holding tanks; and
transferring the second subset of the plurality of treating solutions between treatment baths and corresponding holding tanks.

17. The method according to claim 12, wherein the membrane substrate is exposed to the first subset of the plurality of treating solutions in a first sequence, and the membrane substrate is exposed to the second subset of the plurality of treating solutions in a second sequence, and wherein the first sequence and the second sequence are the same.

18. The method according to claim 12, wherein the method comprises processing the membrane substrate in a forward direction by treating the membrane substrate with the first and the third subsets of the plurality of treating solutions.

19. The method according to claim 12, wherein the method comprises processing the membrane substrate in a reverse direction by treating the membrane substrate with the second and the third subsets of the plurality of treating solutions.

20. An apparatus for continuous roll-to-roll processing of a membrane substrate with at least one treating solution, the apparatus comprising:
a first roll and a second roll, the membrane substrate being windable and unwindable on both the first and second rolls;
the at least one treating solution for treating the membrane substrate as the membrane substrate is processed in a forward direction, in a reverse direction, or in both the forward and the reverse direction.

21. A method of treating a membrane substrate with a treating solution in a roll-to-roll process, the method comprising:
processing the membrane substrate in a forward direction by treating the membrane substrate with the treating solution while unwinding the membrane substrate from a first roll to a second roll;
rewinding the treated membrane substrate from the second roll back to the first roll; and
processing the treated membrane substrate in a forward direction by treating the treated membrane substrate with the treating solution while unwinding the treated membrane substrate from the first roll to the second roll.
